(19) United States
(12) Patent Application Publication
(10) Pub. No.: US 2012/0169586 A1
(43) Pub. Date: Jul. 5, 2012

(54) VIRTUAL INTERFACE

(75) Inventor: Charles Alan Mitchell, Fort Wayne, IN (US)

(73) Assignee: CARRIER CORPORATION, Farmington, CT (US)

(21) Appl. No.: 13/329,719

(22) Filed: Dec. 19, 2011

Related U.S. Application Data
(60) Provisional application No. 61/429,335, filed on Jan. 3, 2011.

(51) Int. Cl. G09G 5/00

(52) U.S. Cl. 345/156

(57) ABSTRACT

A virtual interface including a virtual screen generator configured to produce a virtual display screen, a display generator configured to project at least one virtual display element onto the virtual display screen, and at least one sensor configured to detect interaction with the at least one virtual display element.

### CROSS REFERENCE TO RELATED APPLICATION

This is a Non-Provisional Application of U.S. Provisional Application No. 61/429,335 filed Jan. 3, 2011.

### BACKGROUND OF THE INVENTION

Exemplary embodiments pertain to the art of human/machine interfaces and, more particularly, to a virtual interface.

Human-machine interfaces have made considerable developments over the last century. Inputting information to a machine using knobs and levers progressed to alpha-numeric keyboards, voice commands and the like. Over time, input devices such as computer mice were developed to provide a more flexible interface to machines such as computers. Recently, touch screen displays have been developed to serve as an interface to machines in a wide variety of applications. Touch screen or electronic visual displays detect a presence and location of a touch within a display area. Touch screens allow a person to interact directly with what is displayed as opposed to indirectly such as moving a curser with a mouse. Touch screen displays are being used a wide range of appliances. Touch screen can be found in control panels for a wide range of applications, from complex manufacturing systems to everyday household devices. Touch screens are also used in hand held computers and wireless telephone devices. More recently, computer game interfaces have been developed that sense movement indirectly, such as through a game controller, or directly sense real-time movement of a participant by analyzing acquired camera images.

### BRIEF DESCRIPTION OF THE INVENTION

Disclosed is a virtual interface including a virtual screen generator configured to produce a virtual display screen, a display generator configured to project at least one virtual display element onto the virtual display screen, and at least one sensor configured to detect interaction with the at least one virtual display element.

Also disclosed is a method of detecting a user input through a virtual interface. The method includes projecting at least one virtual display element onto a virtual display screen formed from a plurality of particles, and sensing an input at the at least one virtual display element.

### BRIEF DESCRIPTION OF THE DRAWINGS

The following descriptions should not be considered limiting in any way. With reference to the accompanying drawings, like elements are numbered alike:

FIG. 1 is a perspective view of a virtual interface in accordance with an exemplary embodiment;

FIG. 2 is a schematic view of the virtual interface of FIG. 1; and

FIG. 3 is a flow chart illustrating a method of detecting a user input through the virtual interface in accordance with an exemplary embodiment.

### DETAILED DESCRIPTION OF THE INVENTION

A detailed description of one or more embodiments of the disclosed apparatus and method are presented herein by way of exemplification and not limitation with reference to the Figures.

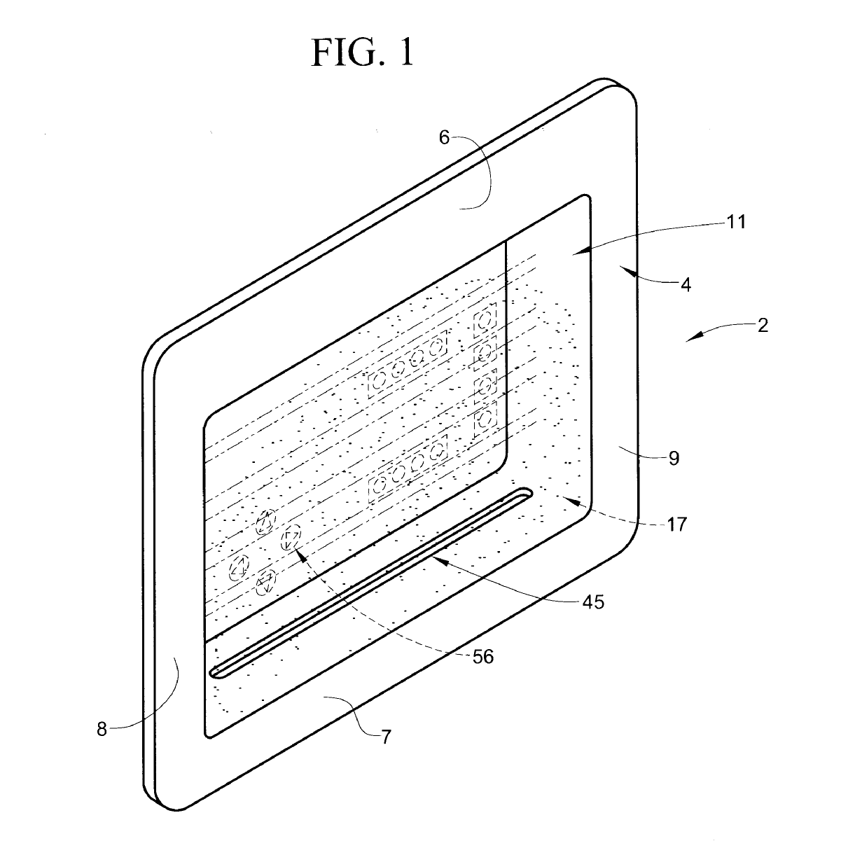

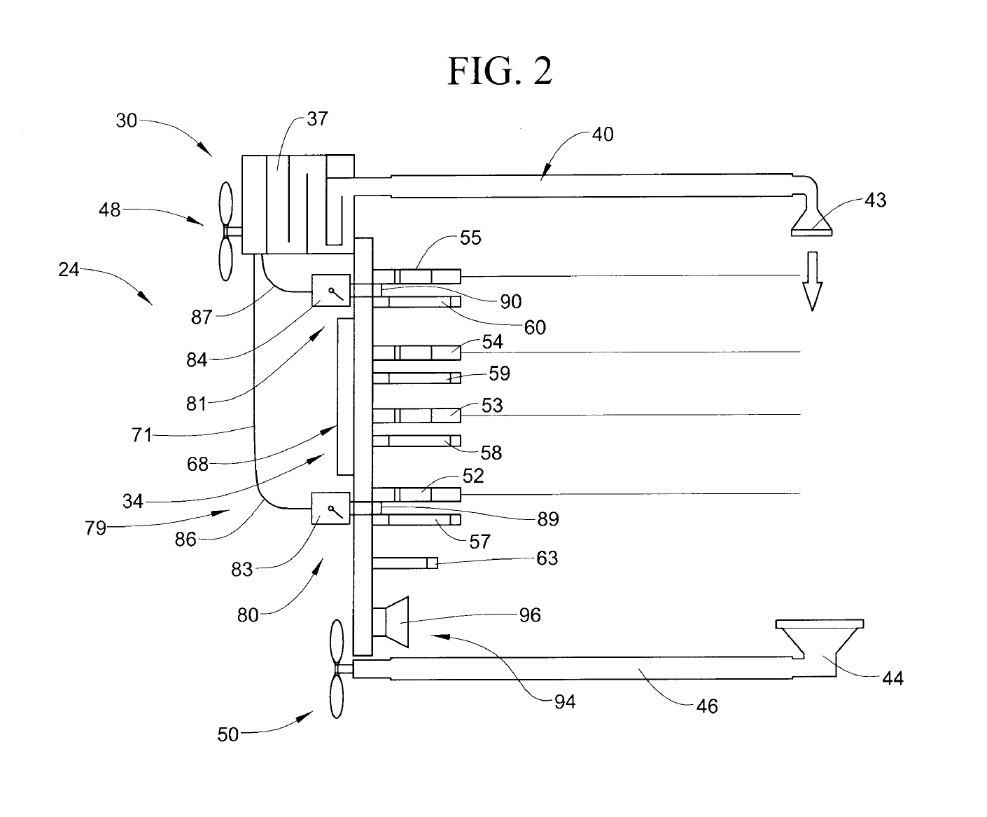

With reference to FIGS. 1 and 2, a virtual interface in accordance with an exemplary embodiment is indicated generally at 2. Virtual interface 2 includes a frame member 4 having first and second opposing side members 6 and 7 that are joined to third and fourth opposing side members 8 and 9 to collectively define a virtual display screen zone 11. As will be discussed more fully below, virtual display screen zone 11 supports a virtual display screen 17 that is formed from a plurality of random, un-associated particles. Virtual display screen 17 is generated by a virtual display screen system 24 that includes a virtual screen generator 30 and a display generator 34.

Virtual screen generator 30 includes a screen medium system or mist generator 37 that transforms random particles such as water particles, into virtual display screen 17. Screen medium system 37 includes a screen delivery conduit 40 having a particle outlet 43. Particle outlet 43 transforms the water particles into a mist that is emitted into screen zone 11. The particles are collected through a particle inlet 44 that is arranged below a particle collector 45 formed on side member 7. Particle inlet 44 is connected to a particle inlet conduit 46 which leads to a collection zone (not shown). A first fan 48 generates an air flow that is passed through screen delivery conduit 40 to create the mist that is passed into screen zone 11. A second fan 50 generates suction in particle inlet conduit 46 that draws in the mist through particle collector 45. In this manner, virtual screen generator 30 creates a continuous sheet of mist that forms virtual display screen 17 within screen zone 11.

In further accordance with the exemplary embodiment, display generator 34 includes a plurality of light emitting devices 52-55 that are configured to generate one or more virtual display elements, such as shown generally at 56, on virtual display screen 17. The particular form/shape, color, and other attributes of virtual display element 56 can vary. Light emitting devices 52-55 can take on a variety of forms such as light emitting diodes (LEDs), laser diodes, and the like. Display generator 34 also includes a plurality of sensors 57-60 arranged adjacent to corresponding ones of the plurality of light emitting devices 52-55. In accordance with one aspect of the exemplary embodiment, sensors 57-60 take the form of optical sensors that detect movement at or interaction with the one or more virtual display elements 56. In addition to sensors 57-60, display generator 34 includes a temperature sensor 63. Light emitting devices 52-55, sensors 57-60 and temperature sensor 63 are electrically connected to a central processing unit (CPU) 68.

As will be discussed more fully below, CPU 68 signals virtual screen generator 30 to generate a virtual display screen, and light emitting devices 52-55 to create the one or more virtual display elements 56. Upon sensing a virtual input to the one or more virtual display elements, CPU 68 generates a perceivable feedback signal and a control signal. The perceivable feedback signal is passed to a tactile feedback system 79. Tactile feedback system 79 includes first and second feedback members 80 and 81 that take the form of air puffers 83 and 84. Air puffers 83 and 84 are fluidly connected to fans 48 through corresponding first and second conduits 86 and 87. Air puffers 83 and 84 are also fluidly connected to corresponding output members 89 and 90. Conduits 86 and 87 selectively deliver a puff of air from fan 48 to output members 89 and 90. That is, upon detecting an input through virtual display element 56, a puff of air is passed to the area of the selected virtual display element to provide a tactile feedback to an operator. In addition to tactile feedback, CPU 68 generates an audible feedback through an audible feedback system 94 that is operatively coupled to a speaker 96. Speaker 96 is configured to emit, for example, a “click” sound upon sensing an input through a virtual display element 56.

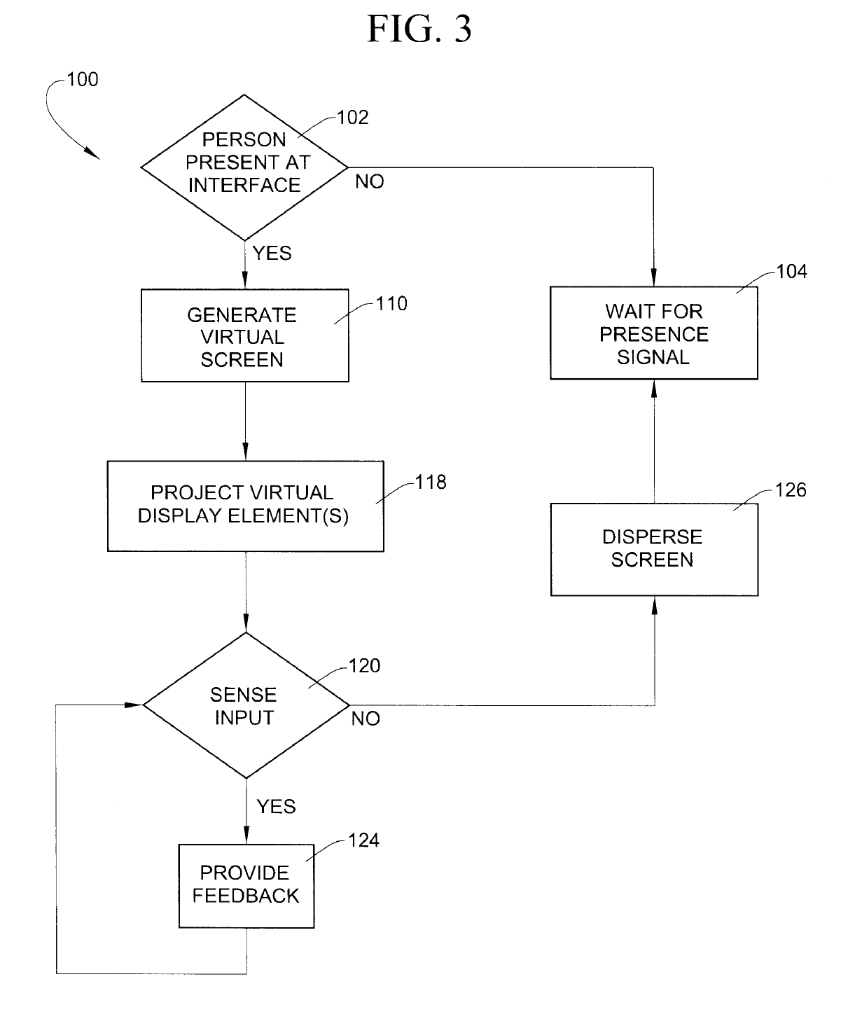

Reference will now follow to FIG. 3 in describing a method 100 of detecting a user input to a virtual interface. Initially, a determination is made in block 102 whether a person is present at virtual interface 2. If no presence is detected, virtual interface 2 awaits a “presence” signal in block 104. If a presence signal is received, CPU 68 signals virtual screen generator 30 to generate a virtual display screen as indicated in block 110. Once the virtual display screen is created, display generator 34 is signaled to create one or more predetermined virtual display elements as indicated in block 118. At this point, CPU 68 awaits an input signal that is passed from one or more of sensors 57-60 as indicated on block 120. Once an input signal is received, CPU 68 signals tactile feedback system 79 to emit a tactile feedback to the area of the sensed input as indicated in block 124. CPU 68 also signals auditory feedback system 94 to emit an audible signal. At this point, CPU 68 awaits further inputs to the one or more virtual display elements. CPU 68 could also be configured to log and store an input data history for later review. If, after a predetermined time period, no inputs are sensed, the virtual display screen is dispersed as indicated in block 126 and virtual interface 2 waits for a presence signal as indicated on block 104.

At this point it should be understood that the exemplary embodiments provide a system for receiving control inputs though an interface that does not exits in the conventional physical sense. The screen is formed from random particles that are easily dispersed when not needed. The virtual display elements can be configured to represent a wide array of display options and provide different display options dependent upon each selection. In this manner, the virtual display can be employed in environments in which direct physical contact with a display screen is not desirable. For example, the virtual interface can be incorporated in to a wide array of environments such as surgical theaters, explosive environments, chemical environments and the like. It should also be understood that while the virtual display screen is described as being formed from water particles forming a mist, a wide array of other particles, such as dust particles, smoke particles and less tangible particles could be employed depending upon particular environmental conditions/constraints/needs and the like. In short, the virtual display need be merely a somewhat perceivable (visually) background onto which a virtual display element can be projected. The virtual display need not be tactilely perceivable.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A virtual interface comprising:
a virtual screen generator configured to produce a virtual display screen;
a display generator configured to project at least one virtual display element onto the virtual display screen; and
at least one sensor configured to detect interaction with the at least one virtual display element.

2. The virtual interface according to claim 1, wherein the virtual screen generator comprises a mist generator configured to create a mist formed from particles, the particles establishing the virtual display screen.

3. The virtual interface according to claim 2, wherein the mist generator includes a particle outlet and a particle inlet, the virtual display screen being defined between the particle outlet and the particle inlet.

4. The virtual interface according to claim 2, wherein the particles establishing the virtual display screen comprise fluid particles.

5. The virtual interface according to claim 1, wherein the display generator includes a plurality of light emitting devices.

6. The virtual interface according to claim 5, wherein the plurality of light emitting devices include at least one of a light emitting diode (LED) and a laser diode.

7. The virtual interface according to claim 1, wherein the at least one sensor includes an optical sensor configured and disposed to detect an interaction with the at least one virtual display element.

8. The virtual interface according to claim 1, wherein the at least one sensor also includes a temperature sensor configured and disposed to detect a presence of a user at the virtual interface.

9. The virtual interface according to claim 1, further comprising: a feedback system operatively connected to the at least one sensor, the feedback system being configured and disposed to provide a perceivable feedback to a user upon the at least one sensor detecting an interaction with the at least one virtual display element.

10. The virtual interface according to claim 1, wherein the feedback system includes an air puffer operatively connected to the at least one sensor, the air puffer being configured and disposed to emit an amount of air upon the at least one sensor detecting an interaction with the at least one virtual display element.

11. The virtual interface according to claim 1, wherein the feedback system includes a speaker element operatively connected to the at least one sensor, the speaker element being configured and disposed to emit a sound upon the at least one sensor detecting an interaction with the at least one virtual display element.

12. A method of detecting a user input through a virtual interface, the method comprising:
projecting at least one virtual display element onto a virtual display screen formed from a plurality of particles; and
sensing an input at the at least one virtual display element.

13. The method of claim 12 further comprising:
detecting a presence of a user at a virtual interface zone; and
generating the virtual display screen upon detection of the presence of the user.

14. The method of claim 13, wherein detecting the presence of a user includes detecting a change in temperate at the virtual interface zone.

15. The method of claim 13, further comprising: dispersing the virtual display screen upon sensing an absence of a presence of a user.

16. The method of claim 13, wherein generating the virtual display screen includes creating a mist at the virtual interface zone.

17. The method claim 16, wherein creating a mist includes initiating a controlled dispersal of a plurality of liquid particles at the virtual interface zone.

18. The method of claim 12, further comprising: providing a tactile feedback upon sensing the input at the at least one virtual display element.

19. The method of claim 18, wherein providing the tactile feedback includes emitting a puff of air at the at least one control element.

20. The method of claim 12, further comprising: generating an audible feedback upon sensing the input at the at least one virtual display element.
